(19) United States
(12) Patent Application Publication
(10) Pub. No.: US 2009/0218514 A1
(43) Pub. Date: Sep. 3, 2009

(54) MULTI-SPOT INVESTIGATION APPARATUS

(75) Inventors: Derk Jan Wilfred Klunder, Geldrop (NL); Maarten Van Herpen, Heesch (NL); Marcello Balistreri, Rosmalen (NL); Coen Liedenbaum, Oss (NL); Menno Prins, Rosmalen (NL); Reinhold Wimberger-Friedl, Veldhoven (NL); Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,842

(22) PCT Filed: Dec. 7, 2005
(86) PCT No.: PCT/IB2005/054094

§ 371 Date: Jun. 5, 2007

(30) Foreign Application Priority Data
Dec. 10, 2004 (EP) 04106477.5

(51) Int. Cl. G01J 1/58

(52) U.S. Cl. 250/459.1; 250/458.1

(57) ABSTRACT

The invention relates to a method and an apparatus for the investigation of a sample material by multiple sample light spots (501) generated by evanescent waves. An array of source light spots (510) is generated by a multi-spot generator, e.g. a multi-mode interferometer (106), and mapped onto sample light spots (501) in a sample layer (302) by (micro-)lenses (202, 203) or by the Talbot effect. The input light (504) of the source light spots (510) is shaped such that all of it is totally internally reflected at the interface between a transparent carrier plate (301) and the sample layer (302). Thus the sample light spots (501) consist of evanescent waves only and are restricted to a limited volume. In a preferred application, fluorescence stimulated in the sample light spots (501) is detected with spatial resolution by a CCD array (401).

The invention relates to a method and an apparatus for the investigation of a sample material with an array of light spots.

From the WO 02/097406 A1 an apparatus for the investigation of biological sample material is known wherein a laser beam is split into a plurality of excitation beams by a diffractive device. The excitation beams are guided to a platform storing the sample material, where fluorescence is stimulated by an array of sample light spots. Said fluorescence is measured spatially resolved with a CCD array in order to gain information on the presence and/or amount of sample material.

Based on this situation it was an object of the present invention to provide means for an efficient and at the same time precise investigation of a sample material with light.

This object is achieved by an apparatus according to claim 1 and a method according to claim 16. Preferred embodiments are disclosed in the dependent claims.

According to its first aspect, the invention comprises an apparatus for the treatment of a sample material with light. As the treatment may particularly serve for investigating the sample material, the apparatus will also be called “investigation apparatus” in the following without limiting the scope of the invention. Moreover, the term “sample material” is to be understood in a very general sense, comprising for instance chemical elements, chemical compounds, biological material (e.g. cells), and/or mixtures thereof. The apparatus comprises the following components:
a) A storage unit which contains a transparent carrier and a sample layer, wherein the sample layer is disposed adjacent to one side of the carrier (called “sample side” in the following) and wherein the sample layer may store the sample material that shall be treated. While the carrier may in principle have any three-dimensional shape, it is preferably shaped as a plate with two parallel sides, one of which is the aforementioned sample side. The carrier typically consists of glass or a transparent polymer. The sample layer may also have an arbitrary shape and comprise for example a division into compartments. Typically it is an empty cavity that may be filled with the sample material, for example an aqueous solution of biological molecules. In certain embodiments, the sample layer may also comprise probes, i.e. sites (molecules) which may bind the sample material.
b) A multi-spot generator (abbreviated MSG in the following) for the generation of “input light”. Said input light may typically be provided at the output side of the MSG as an array of light spots, which will be called “source light spots” in the following to distinguish them from other types of light spots. The array may have a regular arrangement of source light spots, e.g. as a rectangular matrix. Moreover, the source light spots may particularly all have (approximately) the same shape and intensity.
c) A transmission section for the transmission of input light from the MSG into the transparent carrier of the storage unit. If the MSG produces source light spots, images thereof are generated on the inner surface of the sample side of the carrier. Moreover, all of the input light that reaches the inner surface shall be totally internally reflected there. Due to this total internal reflection (TIR), sample light spots are generated in the adjacent sample layer by evanescent waves only, and no input light is able to propagate directly into the sample layer. Several ways to achieve the required conditions for TIR will be discussed below in connection with preferred embodiments of the invention.

An investigation apparatus of the aforementioned kind has two main advantages: First, the sample material in the sample layer is investigated at a plurality of (sample) light spots simultaneously, wherein the processes take place in each spot separately. This parallelism speeds up the whole treatment procedure, allows to measure multiple analytes simultaneously, and improves the accuracy due to a better signal-to-noise ratio. A second advantage is that the sample light spots are generated by evanescent waves only which implies that their volume is very small and restricted to the immediate vicinity of the interface between the carrier and the sample. Thus undesirable interactions with sample material elsewhere is avoided, which again improves the signal-to-noise ratio.

According to a preferred embodiment, the storage unit comprises a cover that is disposed at a distance from the sample side of the carrier. Both the carrier and the cover may particularly be plates defining a flat sample chamber between them, wherein the layer of the sample chamber that is adjacent to the carrier plate constitutes the sample layer. The cover may particularly be transparent for light in order to allow the passage of light originating in the sample layer.

There are several ways to realize a multi-spot generator MSG suited for the investigation apparatus. Preferably the MSG may comprise an amplitude mask, a phase mask, a holographic mask, a diffractive structure, a (micro-)lens array, a Vertical Cavity Surface-Emitting Laser (VCSEL) array and/or a multi-mode interferometer (MMI) for the generation of an array of source light spots at the output side of the MSG. Some of these embodiments will be described in more detail in connection with the Figures.

In a preferred embodiment of the invention, the MSG comprises a (single) light source for generating a primary light beam and an optical multiplication unit for splitting the primary light beam into an array of source light spots at the output side of the MSG. The multiplication unit may for example be realized by an MMI as will be described in more detail below. The splitting of a primary light beam has the advantage that only one light source (or a few light sources) is needed and the resulting source light spots have automatically the same features (wavelength, shape, intensity etc).

In a further development of the aforementioned embodiment, the MSG comprises a beam shaping unit for shaping the primary light beam according to a desired intensity pattern. Said beam shaping unit may for example comprise a mask element, a refractive element and/or a reflective element, wherein said elements block certain (particularly central) parts of the primary light beam. As will be better understandable in connection with the Figures, the blocking will affect just those light rays that would not be totally internally reflected at the inner surface of the carrier.

In a preferred embodiment of the invention, the MSG is adapted to generate an array of source light spots of coherent light, wherein said light generates a Talbot pattern during its further propagation. Due to the self-imaging character of the Talbot effect, the source light spots are periodically reproduced at certain distances, such that an image of them can be generated at the inner surface of the sample side of the carrier. An advantage of this application of the Talbot effect is that the transmission section requires a minimum of optical elements (lenses). For the generation of coherent source light spots, the MSG may particularly comprise one coherent light source.

There are many different ways to achieve the conditions of a TIR at the inner surface of the carrier. In a preferred realization, the investigation apparatus comprises a masking array of absorbing elements, of reflecting elements and/or of refracting elements, wherein said elements blend out parts of the input light from the MSG that would not be totally internally reflected at the inner surface of the carrier.

In a further development of the aforementioned embodiment, at least one detector element (e.g. a photodiode) is disposed in the shade of at least one of the absorbing, reflecting or refracting elements of the masking array. Due to its position, the detector element will not be reached by input light from the MSG, but it can be reached by light originating in the sample layer, for example by fluorescence light stimulated in the sample light spots. The detector element therefore allows a measurement of signals from the sample layer in “reverse direction” without being disturbed by the input light.

As was already mentioned, the apparatus described above may be applied for any desired kind of treatment of the sample material by light spots. Thus it may for example be used to initiate certain chemical reactions of the sample material in the limited volume of the sample light spots. In another, very important class of applications the objective is to detect, monitor and/or measure signals coming from the sample layer, particularly to measure fluorescence that was stimulated by the sample light spots. For these applications the apparatus preferably comprises at least one detector device for detecting light generated in the sample a layer. The detector device may for example be realized by photo multiplier tubes.

Preferably the aforementioned detector device comprises at least one array of detector elements, for example a CCD array, and an optical system for mapping the sample layer onto said array. Thus the emissions coming from the sample light spots will be directed to different detector elements allowing a spatially resolved measurement of the signals from the separate sample light spots. In this way a plurality of different measurements and/or a plurality of repeated measurements of the same kind can be executed in parallel.

In many cases, for example during the observation of fluorescence, the signal light that is generated in the sample layer propagates in all directions. Thus it may be detected in “forward direction”, i.e. after traveling in the same direction as the input light propagates from the MSG to the storage unit. Alternatively, signal light from the sample layer may be detected in “reverse direction”, i.e. a direction opposite to the propagation direction of the input light. A measurement in reverse direction has the advantage that the signal light from the sample layer does not have to travel largely through the sample where noise might be added. Moreover, the measurement in reverse direction is preferable with respect to sample-handling because as there are no optics or detectors behind the sample, the sample can easily be connected to the system and there is no need for protecting the backside of the sample against e.g. dust.

In order to allow for a measurement in reverse direction, the transmission section preferably comprises a (dichroic) beam splitter that directs input light from the MSG to the sample layer and signal light from the sample layer to a detector device. The beam splitter may particularly comprise dichroic components that show different optical behavior for different wavelengths of light, for example prisms that transmit input light of a first wavelength and simultaneously reflect fluorescence light of other wavelengths.

The investigation apparatus described above allows the investigation of an area within the sample layer by multiple sample light spots. In certain cases, said investigated area will not cover the whole sample layer but only a fraction thereof. In order to allow an investigation of the whole sample layer in these cases, the apparatus is preferably adapted to shift the array of sample light spots relative to the sample layer. This shifting may for example be achieved by a scanning unit that selectively guides light coming from the MSG or by moving the MSG (or a component of it, e.g. a mask array).

According to a further development of the aforementioned embodiments that allow a movement of the sample light spots, the apparatus is adapted to identify and re-localize positions of the sample light spots relative to the sample layer. This makes it possible to repeat a measurement at certain locations in the sample layer at least one times, thus allowing to gain additional information from a temporal development at said locations.

When the propagation of signal light emitted at the sample light spots of the sample layer is analyzed in more detail, it can be found that a certain fraction of this light will be totally internally reflected at the side of the carrier opposite to the sample side (called “outer side” in the following) and will thus be lost for detection. Such light has been called light of the “SC-modes” in literature (for details see WO 02/059583 A1, which is incorporated into the present specification by reference). According to a preferred embodiment of the invention, diffractive structures will be provided at the outer side of the carrier plate, wherein said structures are adapted to couple out signal light of the SC-modes, i.e. light from inside the carrier that would be totally internally reflected at a normal (smooth) outer side of the carrier plate. Due to the exploitation of the SC-modes, the signal gain can be significantly increased.

The invention further comprises a method for the treatment of a sample material with light, wherein said material is present in a sample layer adjacent to a “sample side” of a transparent carrier. The method comprises the propagation of input light through the carrier such that it is totally internally reflected at the inner surface of the aforementioned sample side of the carrier and thus generates an array of sample light spots in the sample layer by evanescent waves.

The method comprises in general form the steps that can be executed with an investigation apparatus of the kind described above. Therefore, reference is made to the preceding description for more information on the details, advantages and improvements of that method.

According to a preferred embodiment of the method, an array of source light spots of coherent light is generated from which light propagates by the Talbot effect. Due to the self-imaging character of the Talbot effect, an image of the array of source light spots may then be generated in the sample layer (or, more precisely, at the inner surface of the sample side of the carrier) with a minimum of optical elements if the sample layer is disposed at the Talbot distance or a multiple thereof.

The sample light spots may particularly be generated by an array of corresponding light beams, wherein said light beams are preferably generated by shaping and then splitting a primary light beam. In this way a plurality of identical light beams with required characteristics can be readily created.

In a further development of the method, signal light emitted by the sample material at the sample light spot is detected, wherein the result of said detection may be just a binary value (detected/not-detected) or a continuous value of a measured light quantity. The light emission from the sample material may particularly be excited by the evanescent light of the sample light spots.

In order to increase of the signal gain, light emitted from sample material in the sample layer that would not be able to leave the carrier due to TIR, i.e. light of the so-called SC-modes, can be coupled out of the carrier by diffraction.

A further development of the method is characterized in that the sample layer is scanned with an array of sample light spots, wherein identical positions of the array are reproduced at least one times. Thus treatments can be repeated as often as desired in different locations of the sample layer. In a particular application, this can be used for the detection of occupied binding sites in the sample layer, preferably for the detection of a fluorescent labeling element bound to probes in the sample layer. The method comprises in this case the scanning of the sample layer with respect to an array of sample light spots and the detection of target specific responses, e.g. fluorescent light, with a detection system. If the size of the sample light spots is chosen small enough, the scanning speed is fast enough, and the concentration of binding sites is low, only one occupied binding site will be irradiated at the same time. A location in the sample layer is classified as an occupied binding site if a target specific response is observed in repeated scans of said location. Such repeated scans particularly allow to discriminate between specific and nonspecific binding.

In the following the invention is described by way of example with the help of the accompanying drawings in which:

FIG. 1 shows the principle setup of an investigation apparatus according to the present invention;

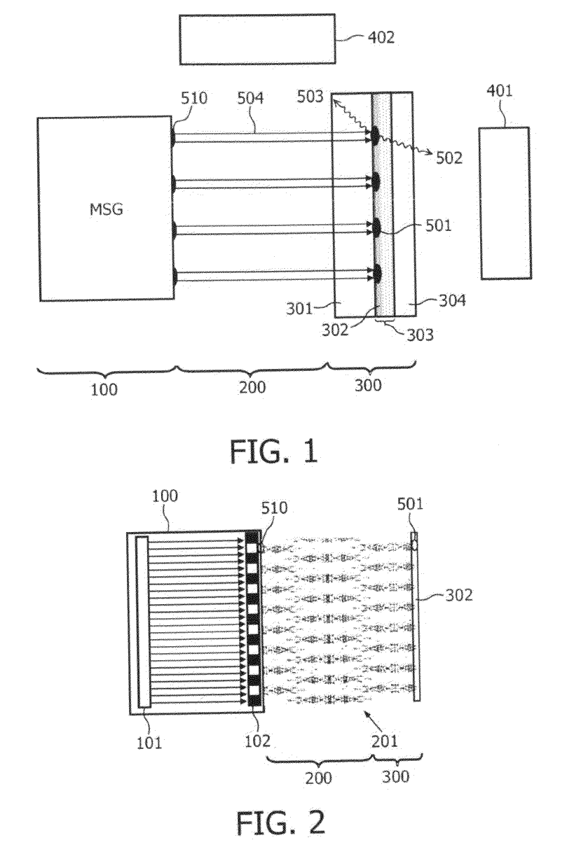

FIG. 2 shows the generation and propagation of multiple light spots by means of the Talbot effect;

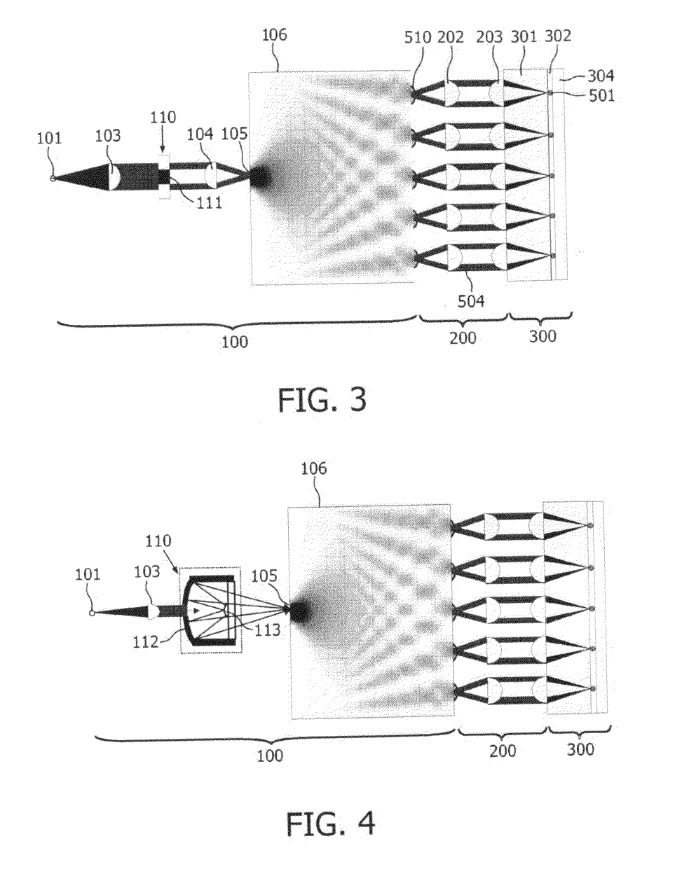

FIG. 3 shows the shaping of a primary light beam with a mask;

FIG. 4 shows the shaping of a primary light beam with mirrors;

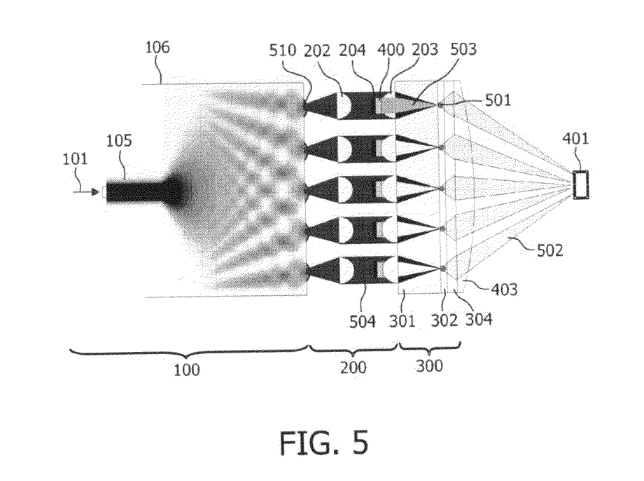

FIG. 5 shows the generation of multiple sample light spots by means of a multi-mode interferometer with a suppression of light that is not totally internally reflected;

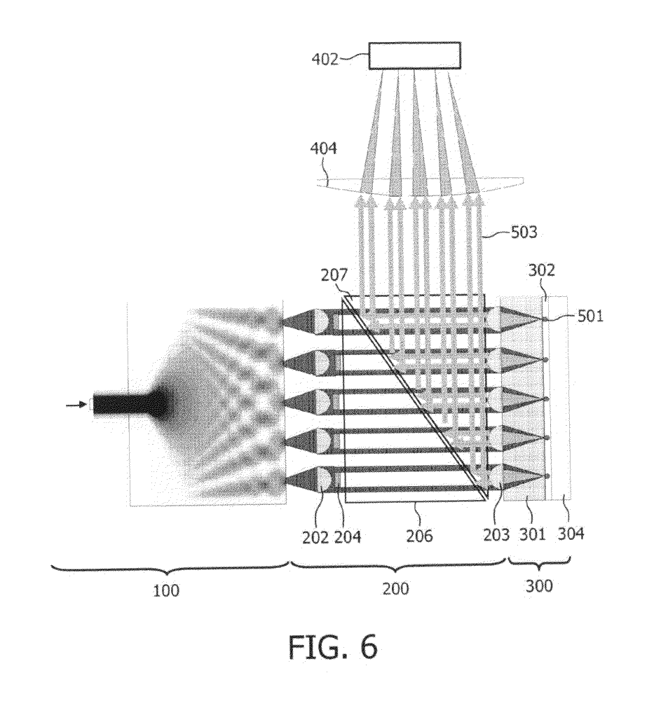

FIG. 6 shows a setup analogous to that of FIG. 5 with a beam splitter for a measurement of fluorescence in reverse direction;

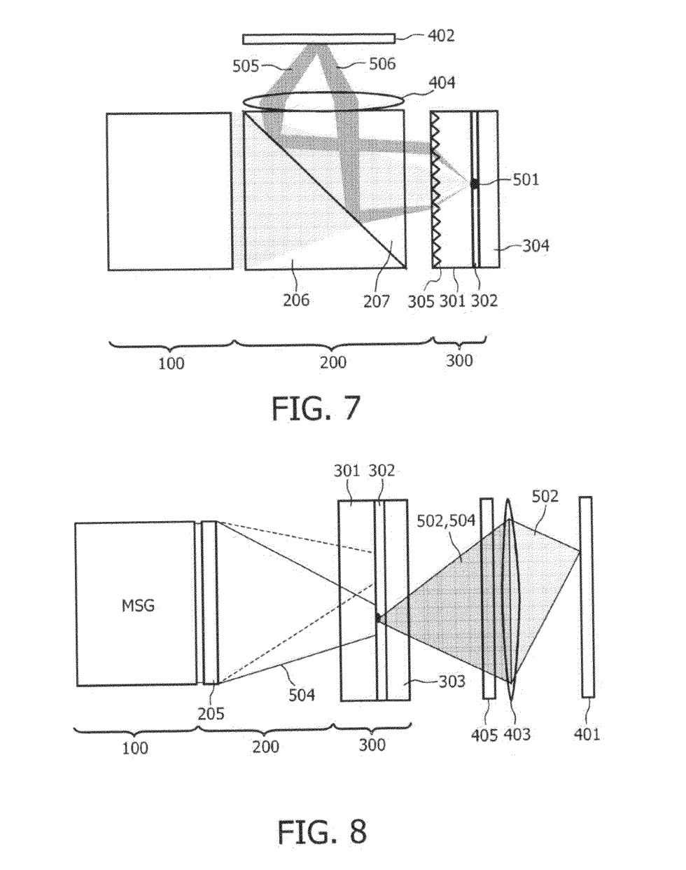

FIG. 7 shows a setup analogous to that of FIG. 6 with means to capture fluorescence light of SC-modes;

FIG. 8 shows a setup with a scanning unit for scanning an array of multiple light spots through a sample.

It should be noted that the Figures are not drawn to scale and that features disclosed in the different Figures and embodiments may be arbitrarily combined in an investigation apparatus according to the present invention.

In (bio-)chemical assays fluorescence of a molecule/sample is for example used for measuring the concentration of a molecule in a solution or for detecting a bonding event (e.g. adhesion of the molecule at a layer). Ideally one would like to use a sensing array as it allows to measure multiple events, species of molecules and the location of molecules, depending on the properties of the bonding layer and the excitation light. The present invention addresses this need while trying to simultaneously improve on three points: analytical performance (sensitivity, specificity, and speed), ease of use (robustness, integration), and costs.

In FIG. 1, the principle setup of an investigation apparatus according to the present invention is shown. Said investigation apparatus basically consists of four components or subsystems:
A multi-spot-generator 100 (abbreviated “MSG” in the following) for the generation of an array of multiple source light spots 510 at its output side. Said source light spots 510 typically are (approximately) circular in shape with a diameter ranging from 0.5 μm to 100 μm. Moreover, the distance between two neighboring spots 510 typically also ranges from 0.5 μm to 100 μm. Different possible embodiments of the MSG 100 will be discussed in connection with the other Figures.
A transmission section 200 that has the task to transmit “input light” from the source light spots 510 to a storage unit 300 containing the sample. While the transmission section may in principle be simply a space filled with air or another medium, it typically comprises dedicated optical components to achieve the desired transmission of input light from the source light spots 510 to sample light spots 501 in the sample.
The aforementioned storage unit 300 for the storage and keeping of a sample material that shall be investigated. Though the storage unit 300 may in principle be realized in many ways, most realizations will comprise the components shown in FIG. 1. These components are: (i) a substrate or carrier 301 that is transparent for the input light generated by the MSG 100 and that may for example be a glass plate; (ii) a sample chamber 303 which can be filled with a fluid containing the sample material (e.g. biological molecules solved in water); (iii) a cover plate 304 which follows and borders the sample chamber 303 and which may also consist of a transparent material like glass (in other embodiments of the storage unit the cover plate may be missing). The side of the carrier plate 301 that contacts the sample chamber 303 is the so-called “sample side”, and the thin layer of the sample chamber 303 that is adjacent to this sample side constitutes a so-called “sample layer” 302 in which the investigation of the sample material shall take place. For the investigation the source light spots 510 generated by the MSG 100 are first mapped to images on the inner surface of the sample side of the carrier plate 301, where all of the light is totally internally reflected due to the particular design of the setup. As a consequence of this total internal reflection (TIR), evanescent waves of the light propagate a small distance into the adjacent sample chamber 303 creating “sample light spots” 501 within the sample layer 302. The light of these sample light spots 501 may for example stimulate fluorescence of the sample material with an (isotropic or anisotropic) emission of fluorescence light in forward direction (ray 502) and reverse direction (ray 503).
A detector system for the measurement of light coming from the sample layer 302. The detector system may (alternatively or simultaneously) comprise a “forward detector” 401 for the detection of signal light 502 emitted in forward direction and a “reverse detector” 402 for the detection of signal light 503 in reverse direction.

The main advantages of an investigation apparatus according to FIG. 1 are:
Simultaneous/parallel excitation of the complete array.
Simultaneous/parallel detection of the fluorescence in the complete array.
No moving elements, making the design potentially cheap and stable.
Evanescent field excitation results in an excitation volume concentrated at the surface of the sample chamber, i.e. in the sample layer. This has the advantage that minimal background is generated from the bulk fluid, i.e. that the bulk fluid does not need to be removed or washed away to perform the measurement (so-called homogeneous assay).
Allows easy separation of the excitation light and the fluorescence when suited detection schemes are used, yielding a potential for high signal-to-noise ratios.

Various concrete embodiments and possible realizations of the components of the described investigation apparatus will be explained in the following with reference to FIGS. 2-8.

FIG. 2 shows a preferred way for the transmission of input light from the MSG to the sample, wherein the source light spots 510 that are present on the output side of the MSG 100 finally generate the sample light spots 501 in the sample layer 302. The transmission takes place via the Talbot effect, i.e. the self-imaging of a regular pattern (in this case the array of source light spots 510) that is illuminated with a collimated beam of coherent light.

In order to produce the Talbot effect, the MSG 100 comprises a light source 101 generating a collimated bundle of coherent light. Said coherent light illuminates an amplitude mask 102 (with e.g. a period d=20 μm and an open closed ratio of 50%) that generates a regular pattern of source light spots 510. The array of spots 510 might also be generated by other means, for example a multi-mode interferometer (MMI), a diffractive structure, an array of (micro-)lenses or an array of VCSELs (Vertical Cavity Surface-Emitting Lasers). The source light spots 510 produce by interference the Talbot intensity pattern 201 which propagates through the intermediate distance into the components (glass, water) of the storage unit 300. It is a characteristic of the Talbot effect that the intensity pattern of the source light spots 510 is periodically reproduced at the so-called self-imaging or Talbot distances which depend on the parameters of the setup. If for instance a grating 102 with period d is illuminated coherently, an image appears behind the grating at distances N(2d²/λ), where N is an integer and λ the wavelength of the light. By appropriate choice of the imaging parameters, it is thus possible to generate an image of the array of source light spots 510 at the sample side of the carrier 301. For a detailed discussion of the Talbot effect reference is made to the literature (cf. A. W. Lohmann and J. A. Thomas, Appl. Opt., vol. 29, p. 4337, 1990; W. Klaus, Y. Arimoto and K. Kodate, Appl. Opt., vol. 37, p. 4357, 1998; J. W. Goodman, Fourier Optics, McGraw-Hill, New York, chapter 4, 1996).

The multiple source light spots might also be generated by a phase or holographic mask (which reproduces them roughly at 60% of the Talbot distance).

An important advantage of the aforementioned application of self-imaging is that it minimizes the amount of optical components like lenses in the transmission section 200, making it a simple and robust design.

FIG. 3 shows a preferred realization of the MSG 100, which is characterized in that a primary light beam 105 is shaped first and then split into a plurality of source light spots 510. The subunit for the generation of a primary light beam 105 comprises a (coherent) light source 101, a collimator lens 103, and a focus lens 104. Between the two lenses 103 and 104, a beam shaping unit 110 is disposed for giving the light beam a desired intensity distribution across its section. The beam shaping unit may for example contain a mask element 111 for blending out the central part of the collimated light bundle between the lenses 103, 104.

In a modification of the arrangement of FIG. 3, the beam shaping unit 110 might be located in the optical path behind the focus lens 104 or in front of the collimator lens 103. In this case, the resulting shape of the beam could be adjusted simply by changing the axial position of the beam shaping unit (e.g. the farther a mask element would be behind the focus lens 104, the bigger the produced central shade in the beam would be). The function of such an arrangement would however depend very critically on the exact placement of the optical components.

In alternative embodiments, the beam shaping unit might be a diffractive structure that converts lower spatial frequencies (corresponding to smaller angles of the focused excitation light) into higher spatial frequencies (corresponding to larger angles of the focused excitation light), which would reduce the losses in the optical excitation power. From Fourier optics it is known that a lens can perform a spatial Fourier transform. For a phase plate in front of or behind a lens, the focal plane amplitude distribution is the Fourier transform of the input (apart from a quadratic phase factor).

An example of how a diffractive element instead of the device 110 of FIG. 3 could be used is an embodiment where the collimating lens 103 and the focusing lens 104 are identical and positioned in a 4f configuration (i.e. the elements 101, 103, diffractive element, 104, and 106 have a distance from each other equal to the focal length f of the lenses) with the diffractive element exactly in between the two lenses 103, 104. In this case the image in the focal spot of the focusing lens 104 would be exactly the spatial Fourier transform of the illuminated diffractive element.

In order to show the feasibility of using a diffractive element for beam shaping, consider the case of a one-dimensional sinusoidal phase grating used in the transmission mode, having diffraction efficiency η_{q}=J_{q}(m/2), with q the diffraction order, m the peak-peak phase delay of the grating and J_{q} is the Bessel function of first kind and order q (cf. J. W. Goodman, Fourier Optics, McGraw-Hill, New York, chapter 4, 1996). For a proper choice of the peak-peak phase delay (m), the central order vanishes entirely (e.g., m=1.53π) and all the power is in the higher orders of the grating. By choosing the period of the phase grating sufficiently small, the angle of the first order at the sample side of the carrier plate is sufficiently large (at least larger than the critical angle for TIR at that interface) and all the input power is total internally reflected at this interface. As a consequence, it can be concluded that using a sinusoidal phase grating with proper period and peak-peak phase delay enables to use all the input power for evanescent field excitation of the fluorescence. The total excitation power is only limited by the numerical apertures of the lenses 103, 104. A ID sinusoidal grating is actually a rather realistic example, as for cylindrically symmetric systems (like most optical systems) a ID sinusoidal grating in the radial direction is required.

It should be remarked that positioning the lenses and a diffractive element in a different than the described 4f configuration is also possible, but the image of the second lens 104 is then not exactly the spatial Fourier transform of the illuminated diffractive element anymore and also contains a quadratic phase-factor. Because for fluorescence, the intensity matters and not so much the amplitude distribution, the quadratic phase factor is acceptable in most practical cases.

In a modification of the described embodiment, the diffractive element might be positioned behind the focusing lens 104. An advantage of such an arrangement would be that the image of the second lens 104 is the Fourier transform of the illuminated aperture subtended to the aperture of the second lens plus a quadratic phase factor, implying that the image can be scaled (i.e., the frequency scale of the Fourier transform can be scaled) by translating the diffractive element.

The shaped input light beam 105 that is generated in one of the ways described above is next fed into a beam splitting unit that splits or copies the input light into an array of (identical or similar) source light spots 510 which are presented at the output side of the MSG 100. In the case shown in FIG. 3, the splitting unit is realized by a multi-mode interferometer MMI 106. An MMI consists of a multi-modal optical waveguide. The light of the (preferably single mode) input waveguide or input spot is divided over the modes of the multi-modal waveguide section. At a given cross-section of the MMI, the intensity distribution is an interference pattern between the modes of the MMI. Like for the Talbot effect, the intensity pattern of the MMI is periodic.

By making the MMI 106 tunable, one could avoid problems with the wavelength dependence of the MMI. The intensity pattern at the output side of the MMI could be tuned by changing the propagation constants of the modes. By tuning the MMI, one could also select the number of spots at the output side of the MMI and match the position of the spots with the sample layer or with optics in the transmission section 200. Because the total power in a spot is in first approximation inversely proportional to the number of spots, one could also vary/optimize the excitation power and as a consequence optimize the signal-to-noise ratio of the measurements.

The MMI 106 shown in FIG. 3 may for example generate a one-dimensional (N×1) array of 5 spots, with the following parameters:

Refractive indexes: core (1.6); background (1.5);

Widths: centered input waveguide (2 μm); MMI section (20 μm);

Length: MMI section for 1×5 spots generation (135 μm);

Self-imaging distance (image repeats at this distance): 5417 μm;

Number of modes supported by MMI: 22.

Accurate generation of the multiple spots 510 requires that the MMI is sufficiently wide (the wider the more modes are supported by the MMI). As a rule of thumb the number of modes supported by the MMI should be at least (number of spots+1). Increasing the width of the MMI increases the image quality, but also increases the required length; in good approximation the self-imaging distance depends quadratically on the width of the MMI.

By proper layout of the MMI, two-dimensional (N×M) arrays of spots can be created as well. It should be remarked that the generation of the multiple spots is based on interference and can in principle be performed without significant losses. Another advantage of an MMI is that it is a relatively simple method, which does not require alignment of lenses and period structures.

More details about the principle of the MMI may be found in literature (e.g. R. M. Jenkins et al., Appl. Phys. Lett., vol. 64, p. 684, 1994; M. Bachman et al., Appl. Opt., vol. 33, p. 3905, 1994; L. B. Soldano and E. C. M. Pennings, J. Lightwave Technol., vol. 13, p. 615, 1995).

The array of source light spots 510 that is present at the output side of the MSG 100 is mapped in the transmission section 200 by collimator micro-lenses 202 and focus micro-lenses 203 onto light spots at the (inner surface of) the sample side of the carrier plate 301. Preferably the carrier plate 301 has the same refractive index as the focusing micro-lenses 203 in order to avoid reflections at the interface between these two components. Instead of the arrays of micro-lenses 202 and/or 203, a single (macro) lens could be used as well.

The blending out of the central part of the input light beam 105 to the MMI has the effect that input light 504 reaches the inner surface of the sample side of the carrier plate 301 only under angles of total internal reflection (TIR) (assuming for example that the carrier plate 301 consists of glass and the sample layer 302 is filled with an aqueous solution). This means that the input light 504 produces sample light spots 501 by evanescent waves only, restricting the volume of the sample light spots 501 to the thin sample layer 302 and thus minimizing background. Moreover, no input light 504 will propagate into the sample, allowing an easy separation of excitation light and fluorescence in forward direction.

While an embodiment of the storage unit 300 with a carrier plate 301, a sample layer 302, and a cover plate 304 is shown in FIG. 3 and the other Figures, other arrangements might be used as well. Thus it is particularly possible to use a “sample plate” with a surface structure containing the sample material as it is described in the patent application EP03101893.0 (which is included into the present specification by reference). In this case, the sample plate should have an index of refraction smaller than the carrier plate, in order for TIR to occur. By modifying the surface structure as described in EP03101893, the interval of angles that experience total internal reflection at the interface between the sample layer and the carrier plate can be increased.

The observation of fluorescent light stimulated by the sample light spots 501 can be achieved by different setups which are not depicted in FIG. 3 but will be described in connection with other embodiments of the invention.

FIG. 4 shows an alternative arrangement for the shaping of a primary light beam 105 for the MMI 106. According to this embodiment, the light generated by the (coherent) light source 101 is collimated by a lens 103 and directed on a convex mirror 113. The convex mirror 113 reflects the light to a concave mirror 112 which focuses it to the primary input light beam 105. The mirrors 112, 113 thus constitute a beam shaping unit 110 that generates a primary light beam with the central area blended out as in the arrangement of FIG. 3. The residual processing of said primary light beam 105 is then executed as in FIG. 3 and will not be described again.

FIG. 5 shows an embodiment in which an (unshaped) primary light beam 105 is fed into an MMI 106 that generates an array of source light spots 510 at the output side of the MSG 100. Of course any other a type of MSG could be used for the generation of the source light spots 510, too. In the transmission section 200, each source light spot 510 has an associated collimator micro-lens 202 and an associated focus micro-lens 203 for collimating the input light emitted by the corresponding spot 510 into a parallel light bundle and focusing it to the sample layer 302 of the storage unit 300.

In each parallel light bundle 504 a mask element 204 is arranged between the collimator lens 202 and the corresponding focus lens 203 for blending out the central part of said light bundle 504. As was described in detail with reference to FIG. 3, the remaining part of the light beam reaches the interface between the sample side of the carrier plate 301 and the sample layer 302 at angles that are large enough for TIR. Thus the light spots 501 in the sample layer 302 will be generated by evanescent waves only.

While the mask elements 204 are shown in the parallel light bundle 504 between the lenses 202 and 203, they may as well be disposed in front of the collimator lenses 202 or behind the focus lenses 203. With respect to these embodiments, similar remarks as above concerning the position of the beam shaping unit 110 in FIG. 3 apply.

FIG. 5 further shows detector elements 400 that are each disposed at the backside (i.e. at the side facing the storage unit 300) of the mask elements 204. These detector elements 400 are able to detect fluorescent light 503 emitted from the sample layer 302 in reverse direction.

Moreover, FIG. 5 shows an embodiment for the measurement of fluorescence light 502 emitted in forward direction from molecules in the sample layer 302 that are stimulated by the input light 504. Said fluorescence light 502 is focused by a single (macro) focus lens 403 on the image plane of a detector device 401. Preferably the lens 403 has the same refractive index as the cover plate 304 in order to avoid reflections at the interface between these two components. The detector device may for instance be a CCD array 401 that allows to measure the fluorescence emerging from the spots of the sample layer 302 in a spatially resolved way.

Instead of the single focus lens 403, an array of micro-lenses (similar to the lenses 203) might be used as well. Similarly, the micro-lenses 202 and/or 203 might be replaced by a single macro lens. Moreover, it is also possible to combine the use of mask elements 204 and/or of detector elements 400 with the propagation of input light by the Talbot effect as shown in FIG. 2 (in this case no lenses 202, 203 would be required).

A disadvantage of the measurement of fluorescence in forward direction is that the signal 502 must propagate through components like the sample chamber, the cover plate 304, and one or more lenses, resulting in a parasitic signal (for example due to fluorescence) generated in these components. Detection of the fluorescence in the reverse direction avoids such problems. Moreover, the cover plate 304 needs not be transparent when measuring in reverse direction.

FIG. 6 shows an embodiment for the measurement of fluorescence light 503 in reverse direction. As in the apparatus of FIG. 5, source light spots generated by an MSG 100 are collimated by micro-lenses 202 and focused by focus micro-lenses 203 at sample light spots 501 in the sample layer 302. Again, mask elements 204 behind the collimator lenses 202 blend out the central part of the light beams 504, thus guaranteeing that the sample light spots 501 consist of evanescent waves only.

In contrast to FIG. 5, a dichroic beam splitter consisting of two prisms or wedges 206, 207 is disposed between the mask elements 204 and the focus lenses 203. This beam splitter has a coating such that it transmits the input light 504 and reflects the fluorescence light 503. Other means of separating the excitation and fluorescence light are of course not excluded from the invention.

Fluorescence light 503 emitted from stimulated molecules in the sample layer 302 propagates in reverse direction (i.e. opposite to the excitation light) through the carrier plate 301, the focus lenses 203, and the right wedge 207. At the inclined face of said wedge 207, the fluorescence light 503 is reflected at right angles towards a focus lens 404 which maps it onto a CCD array 402. The fluorescence light may thus be measured separately and undisturbed from the excitation light 504.

It should be remarked that the width of the fluorescence spot collected by focus lenses 203 is determined by the numerical aperture of these lenses; assuming that lenses 202 and 203 have identical numerical apertures it can be understood that the width of the collected fluorescence is roughly identical to the width of the collimated excitation beam 504.

Of course the embodiment of FIG. 6 may be modified in many ways, for example by exchanging single macro-lenses with micro-lenses and vice-versa.

FIG. 7 shows an embodiment of the investigation apparatus similar to FIG. 6 with a measurement of fluorescence in reverse direction. The details of the MSG 100 and the transmission section 200 are left out here, and only one representative sample light spot 501 is shown for clarity. As is discussed in detail in the WO 02/059583 A1, the fluorescence light stimulated in the sample layer 302 can be subdivided into different components or modes according to its propagation behavior in the neighboring materials. One mode that is of particular interest here is the so-called SC-mode which comprises all the fluorescence light that propagates from the sample layer 302 into the glass carrier 301 under such angles that it is totally internally reflected at the (planar) outer side of the carrier plate 301. Thus the light of the SC-modes is normally lost for the detection process.

In order to make this light usable for detection purposes, it is known from the WO 02/059583 A1 to provide a diffraction grating 305 at the outer side of the carrier 301. The grating has the effect that light of the SC-modes is coupled out of the glass carrier 301 and propagates in reverse direction in light bundles 505, 506 that are highlighted in FIG. 7 (light of other modes is not depicted for better clarity). The light of these SC-modes is reflected at the backside of the dichroic prism 207 of the beam splitter (similar to the embodiment of FIG. 6) and projected by a focus lens 404 onto a detector device 402.

FIG. 8 schematically shows an embodiment of the investigation apparatus with a scanning unit 205 following the MSG 100 in the optical path. With the help of this scanning unit 205, the array of source light spots generated by the MSG can be directed onto different sub-areas of the sample layer 302 in the storage unit 300.

When stimulating a sample material with a single light spot, e.g. by using a moving optical pick-up unit (OPU) of a CD/DVD-player above the fixed sample, the maximum fluorescent excitation power is limited by the saturation fluorescent intensity. The measuring time can be decreased and/or the sensitivity can be increased by using the extra available laser power to apply a multi-spot approach as it is subject of the present invention. In this case the generation and scanning of the multi-spots should be done in a simple and cost effective way and preferably with no moving elements.

A first step to achieve a solution of the aforementioned objective comprises the use of the Talbot effect (cf. FIG. 2), because it allows imaging of a (periodic) array of propagating spots at periodic distances without the help of lenses. In this way only the area spanned by the neighboring spots needs to be scanned for the interrogation of the total sample layer. A dynamic scanning unit 205 comprising for example moving optical elements like lenses or mirrors can be used to scan the multi-spots.

Another possibility to move an array of multiple light spots through a sample is to scan the MSG. If for example an aperture array 102 as shown in FIG. 2 is used in the MSG, the apertures only need to be moved in order to move the sample light spots 501. This is an embodiment that requires no moving lenses.

A characteristic feature of the investigation apparatus of FIG. 8 is the single event detection with parallel spots in a scanning optical arrangement. Single event detection requires a certain minimum power and energy of the emitted radiation to be detected by a sensor. The choice of power conditions is elaborated in the following section.

The fluorophores can roughly be divided in different groups by looking to the fluorescence lifetime τ_{fluor}, the cross sections for the absorption σ_{abs}, and the fluorescent quantum efficiency φ (c.f. (S. W. Hell, and J. Wichmann, Opt. Lett. 19, 780, 1994),

| | |
|---|---|
| e.g. Cyanine, Alexa, | τ_{fluor}~1-5 ns, σ_{abs}~10⁻¹⁶ cm², φ = 0.5-1. |
| fluoresceine: | |
| e.g. Ru, Ir: | τ_{fluor}~1 μs, σ_{abs}~10⁻¹⁶ cm², φ = 0.1-0.8. |
| e.g. Eu, Tb: | τ_{fluor}~1 ms, σ_{abs} << 10⁻¹⁶ cm², φ = 0.1-0.5. |
| beads, e.g. | σ_{abs}~10⁻¹²-10⁻¹⁴ cm². |
| 200 nm diameter: | |
| quantum dots: | σ_{abs}~10⁻¹⁵-10⁻¹⁶ cm². |

The saturated fluorescent excitation intensity is

$${I}_{S} = \frac{hc}{λ {τ}_{fluor} {σ}_{abs}} \qquad ( 2 )$$

with h the Planck's constant, c the speed of light, and λ the wavelength of the absorbed light. A saturated-fluorescent excitation intensity Iₛ of several μW's up to several mW's is found for a 0.2 μm² surface area (corresponds with an optical spot size of a DVD optical pickup unit with 0.6 NA and 650 nm). Thus, depending on the used fluorophores and the maximum applicable laser power (e.g. 100 mW at the sample) a few (2-100) up to many (100-100000) Talbot spots can be used in parallel to scan the sensing array.

The fluorescent light excited by the propagating Talbot spots can be detected in the forward and the backward (reverse) propagation direction.

The forward fluorescent detection scheme is shown in FIG. 8. The Talbot spots can be generated by different optical components, e.g. a mask with open and closed section, a multi-mode interferometer, a diffractive structure for generating an array of spots, an array of lenses or an array of VCSELs. The scanning of the Talbot spots over the sample layer 302 can be obtained by scanning the multi-spot light source in the lateral direction. A scanning unit 205 behind the MSG 100 allows to scan the Talbot spots. The sample layer 302 of the storage unit 300 is positioned in the first Talbot plane. The minimal spot size is determined by the diffraction limit.

A filter 405 on the other side of the storage unit 300 is used to block the excitation light 504 from the red-shifted fluorescent light 502. The fluorescent binding events are imaged on a pixelated detector 401 using an achromatic lens 403 (It is not possible to use the Talbot-effect again to image the fluorescent binding events on the detector, because the fluorescent light is incoherent and not necessarily periodic in space).

Servo signals for focusing and tracking could be generated by some spots, e.g. the four spots at the corners of the multi-spot array. The reflected signal at the water interface could be used for focusing and to compensate for tilt. The push-pull signal from pregrooves at the corners of the sample could be used for tracking. A sample actuator with three degrees of freedom could be used to optimize the distance between the light source and the sample and the tilt between these two components.

The detection of the fluorescent light can also be obtained in the backwards direction because the emission is isotropic. As in the embodiments of FIGS. 6 and 7, a dichroic beam splitter is required in this case to direct the backwards fluorescent light towards the detector. Preferably the length of the dichroic beam splitter is chosen such that—ignoring aberrations—the output of the beam splitter is a Talbot image of the input. In that case the input facet of the beam splitter should be in a plane where a Talbot image of the array of input spots is created and the sample side of the carrier 301 should be in a plane where a Talbot image of the output of the beam splitter is created. Other configurations where the input and output facets of the beam splitter are not Talbot planes are also possible, as long as the image at the sample side of the carrier 301 is a Talbot image (ignoring aberrations) of the array of input spots.

The size of the dichroic beam splitter will be roughly 1 mm for a sensing array with a size 1×1 mm². The distance to the first Talbot plane (in air) for a spot pitch of 20 μm and a wavelength of 500 nm is 1.6 mm. In this exemplar case the 1×1 mm² sensing array would be simultaneously scanned by 50×50 Talbot spots.

Forward fluorescence has the disadvantage of absorption in the sample fluid, at least for a dynamic measurement. If one measures just at the end the solution can be replaced by a washing fluid (which might be necessary anyway). Measuring directly in blood is clearly preferable, whenever possible.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, the above description of the Figures and of preferred embodiments of the invention are intended to be illustrative, not limiting, and reference signs in the claims shall not be construed as limiting their scope.

### LIST OF REFERENCE SIGNS

100 multi-spot generator MSG
101 (coherent) light source
102 mask
103 collimator lens
104 focus lens
105 primary light beam/spot
106 multi-mode interferometer MMI
110 beam shaping unit
111 mask element
112 concave mirror
113 convex mirror
200 transmission section
201 Talbot pattern
202 collimator micro-lens
203 focus micro-lens
204 mask element
205 scanning unit
206 prism of dichroic beam splitter
207 prism of dichroic beam splitter
300 storage unit
301 carrier plate
302 sample layer
303 sample chamber
304 cover plate
305 diffractive structure
400 detector element
401 detector in forward direction
402 detector in reverse direction
403 focus lens
404 focus lens
405 filter
501 sample light spot
502 fluorescence in forward direction
503 fluorescence in reverse direction
504 input (excitation) light
505 fluorescence in SC-mode
506 fluorescence in SC-mode
510 source light spots

1. Apparatus for the treatment of a sample material with light, comprising
a) a storage unit (300) with a transparent carrier (301) and a sample layer (302) that is disposed adjacent to one side (“sample side”) of the carrier (301);
b) a multi-spot generator MSG (100) for the generation input light (504);
c) a transmission section (200) for the transmission of said input light to the carrier (301), wherein all input light reaching the inner surface of the sample side of the carrier (301) is totally internally reflected there and an array of sample light spots (501) is generated in the sample layer (302) by evanescent waves.

2. The apparatus according to claim 1, characterized in that the storage unit (300) comprises a cover (304) that is disposed at a distance from the sample side of the carrier (301).

3. The apparatus according to claim 1, characterized in that the MSG (100) comprises an amplitude mask (102), a phase mask, a holographic mask, a diffractive structure, a micro-lens array, a VCSEL array and/or a multi-mode interferometer (106) for the generation of an array of source light spots (510) at the output side of the MSG (100).

4. The apparatus according to claim 1, characterized in that the MSG (100) comprises a light source (101) for generating a primary light beam (105) and an optical multiplication unit, particularly a multi-mode interferometer (106), for splitting the primary light beam into an array of source light spots (510) at the output side of the MSG (100).

5. The apparatus according to claim 4, characterized in that the MSG (100) comprises a beam shaping unit (110) for shaping the primary light beam (105), particularly a mask element (111), a refractive element and/or a reflective element (112, 113) for blocking certain parts of the primary light beam.

6. The apparatus according to claim 1, characterized in that the MSG (100) is adapted to generate an array of source light spots (510) of coherent light that produce a Talbot pattern (201).

7. The apparatus according to claim 1, characterized in that it comprises a masking array of absorbing elements (204), reflecting elements and/or refracting elements for blending out parts of the input light generated by the MSG (100) that would not be totally internally reflected at the sample side of the carrier (301).

8. The apparatus according to claim 7, characterized in that at least one detector element (400) is disposed in the shade of at least one masking element (204) of the masking array.

9. The apparatus according to claim 1, characterized in that it comprises at least one detector device (400, 401, 403) for detecting light generated in the sample layer (302).

10. The apparatus according to claim 9, characterized in that the detector device comprises an array of detector elements, particularly a CCD array (401, 402), and an optical system (403, 404) for mapping the sample layer (302) onto said array.

11. The apparatus according to claim 9, characterized in that the transmission section (200) comprises a beam splitter (206, 207) that guides input light from the MSG (100) to the sample layer (302) and light from the sample layer (302) to the detector device (402).

12. The apparatus according to claim 1, characterized in that it is adapted to shift the array of sample light spots (501) relative to the sample layer (302).

13. The apparatus according to claim 12, characterized in that it comprises a scanning unit for selectively guiding input light generated by the MSG (100).

14. The apparatus according to claim 12, characterized that it is adapted to identify and re-localize positions of the sample light spots relative to the sample layer (302).

15. The apparatus according to claim 1, characterized that diffractive structures (305) are provided at the outer side of the carrier (301) that are adapted to couple out light (505, 506) from inside the carrier (301) that would be totally internally reflected without such structures.

16. A method for the treatment of a sample material with light, wherein said material is disposed in a sample layer (302) adjacent to one side (“sample side”) of a transparent carrier (301), comprising the propagation of input light through the carrier (301) such that it is totally internally reflected at multiple spots on the inner surface of the sample side and thus generates an array of sample light spots (501) in the sample layer (302) by evanescent waves.

17. The method according to claim 16, characterized in that an array of source light spots (510) of coherent light is generated from which input light propagates by the Talbot effect.

18. The method according to claim 16, characterized in that a primary light beam (105) is shaped and split into an array of light beams.

19. The method according to claim a 16, characterized in that signal light emitted by the sample material at the sample light spots (501) is detected.

20. The method according to claim 19, characterized in that signal light that would not be able to leave the carrier (301) due to total internal reflection is coupled out by diffraction.

21. The method according to claim 16, characterized in that the sample layer (302) is scanned with the array of sample light spots (501), wherein identical positions of the array are reproduced at least one times.
